(19) United States
(12) Patent Application Publication
(10) Pub. No.: US 2023/0306499 A1
(43) Pub. Date: Sep. 28, 2023

(54) VISION-POWERED AUTO-SCROLL FOR LISTS

(71) Applicant: GOOGLE LLC, Mountain View, CA (US)

(72) Inventors: Kimberly Paterson, Campbell, CA (US); Younghwan Kim, Waterloo (CA); Ethan Owusu, Oakland, CA (US); Jacob Pawak, Cupertino, CA (US); Aveek Purohit, Palo Alto, CA (US)

(21) Appl. No.: 17/656,783

(22) Filed: Mar. 28, 2022

(51) Int. Cl. G06Q 30/06; G06F 3/01; G02B 27/01; G06F 3/0485

(52) U.S. Cl. CPC G06Q 30/0641; G06F 3/013; G02B 27/017; G06Q 30/0633; G06Q 30/0639; G06F 3/0485; G02B 2027/0178

(57) ABSTRACT

A computer-implemented method includes displaying item line entries of at least a portion of a list on a user interface (UI) in a pair of smart glasses worn by a person. The item line entries in the list correspond to different items in a store. The method further includes capturing an image of an item in the store held in hand by the person, based on the captured image, identifying an item line entry in the list corresponding to the item held in hand by the person, and automatically scrolling through the list to the item line entry in the list corresponding to the item held in hand by the person.

### TECHNICAL FIELD

This disclosure relates to smart glasses that add information alongside or to what a wearer sees through the glasses. In particular, the disclosure relates to the use of smart glasses to add information to aid shopping in a store.

### BACKGROUND

Consumers may find shopping lists useful in guiding them in their shopping activities in physical stores (e.g., grocery stores). For some consumers, shopping lists written on paper are difficult to keep track of during shopping, and for other consumers, shopping lists stored in digital format (e.g., on a handheld electronic device) can be equally clumsy to work with while walking through a store and using their hands to pick up items from shelves and place the items in a shopping bag or shopping cart.

### SUMMARY

In a general aspect, a computer-implemented method includes displaying item line entries of at least a portion of a list on a user interface (UI) in a pair of smart glasses worn by a person. The item line entries in the list correspond to different items in a store. The method further includes capturing an image of an item in the store held in hand by the person, based on the captured image, identifying an item line entry in the list corresponding to the item held in hand by the person, and automatically scrolling through the list to the item line entry in the list corresponding to the item held in hand by the person.

In a general aspect, a system includes at least one processor and a memory. The processor is configured to execute instructions stored in the memory to display item line entries of at least a portion of a list on a user interface (UI) in a pair of smart glasses worn by a person. The item line entries in the list correspond to different items in a store. The processor is further configured to execute instructions to capture an image of an item in the store held in hand by a person, based on the captured image, identify an item line entry in the list corresponding to the item held in hand by the person, and automatically scroll through the list to the item line entry in the list corresponding to the item held in hand by the person.

In a general aspect, a system includes at least one processor, a memory, an imaging device, and a user interface in a pair of smart glasses. The imaging device is configured to capture images of an item held in a hand of a person in a store. The at least one processor configured to execute instructions to display a portion of a shopping list of items on the user interface, identify the item held in the hand of the person, and auto scroll the portion of the shopping list of items displayed on the user interface to an item line entry in the shopping list corresponding to the identified item held in the hand of the person.

### BRIEF DESCRIPTION OF THE DRAWINGS

FIG. 1A is a front view of the example pair of smart glasses.

FIG. 1B is a schematic representation of a portion of a grocery shopping list that may be presented on a virtual display of the smart glasses worn by the shopper.

FIG. 2A is a front view of a smart phone that may be used, held, or carried by the shopper.

FIG. 2B is a schematic representation of a grocery shopping list that may be presented on a display portion of the smart phone of FIG. 2A.

FIG. 2C illustrates a user interface of a shopping list app used on smart phone to create grocery shopping lists.

FIG. 3 is a block diagram of an example system configured to implement the concepts and methods described herein.

FIG. 4 is a schematic representation of an example notification on a user interface notifying a shopper that they are at a grocery store and that a grocery list is available.

FIGS. 5A through 5D illustrate example grocery list portions displayed on a user interface (UI) in a pair of smart glasses.

FIG. 6 illustrates an example computer-implemented method for displaying a list of items on a user interface (UI) in a pair of smart glasses.

FIG. 7 shows an example of a generic computer device and a generic mobile computer device.

### DETAILED DESCRIPTION

The present disclosure relates to methods and systems for displaying and updating an electronic shopping list.

A shopping list (e.g., a grocery list) can be displayed in a digital format to a shopper on an electronic device and can be perused, marked, or manipulated in a hands-free manner by the shopper, in accordance with the principles of the present disclosure. Each item in the shopping list may be displayed on a separate line. The shopping list may be updated while the shopper may be walking through a store and, for example, picking up store items by hand from store shelves and placing the store items in a shopping cart or bag for immediate or later purchase.

An egocentric camera (or other imaging device) may record images of a picked-up store item in the shopper's hand. From the images, an electronic device may recognize the picked-up store item, for example, as a particular item line entry in the shopping list and may automatically scroll the shopping list displayed on the electronic device to the particular item line entry in the shopping list. The electronic device may automatically (or in response to the shopper's input (e.g., audio input)) may mark the scrolled-to item line entry in the shopping list as accomplished or completed (e.g., by displaying the particular item line entry with stricken-out text font, or by marking a check box next to the particular item line entry, etc.).

Shoppers may prepare the shopping lists, and view displays of the shopping lists using any of a number of different types of devices, including, for example, handheld devices (smartphones and the like), wearable devices such as hand and/or wrist worn devices (smart watches, smart bracelets, smart rings and the like), head mounted devices (smart glasses, goggles, headsets and the like), neck worn lanyard devices, other mobile devices (tablet computing devices, laptop computing devices and the like), desktop computing devices, smart televisions, assistant devices, and other such devices.

A shopper may view or interact with a shopping list on a first, wearable computing device (e.g., a head mounted display device, or smart glasses, including an egocentric camera) and/or a second computing device (e.g., a mobile computer, a smart phone, etc.).

Example devices that can be used to implement the systems and methods of the present disclosure include, for example, a pair of smart glasses and a smart phone.

Smart glasses (including, e.g., Optical Head-Mounted Display (OHMD), Augmented Reality (AR) glasses, or through Heads Up Display Glasses (HUD)) are wearable devices that add information onto a user's field of view. Electronic and optical components of the smart glasses (e.g., electronic components such as processors, wireless transceivers, batteries, control buttons, in-lens or attached displays, etc.; audio components such as speakers, microphones, etc.; and optical components such as prisms, projectors, and cameras, etc.) (hereinafter “smart glasses components”) can generate and display additional information (e.g., on an in-lens display) alongside what the wearer sees through the glasses. Several of these smart glasses' components are typically either attached to and protrude from a wearable frame of the smart glasses or are enclosed in box-like structures (i.e., legs) attached to the frame.

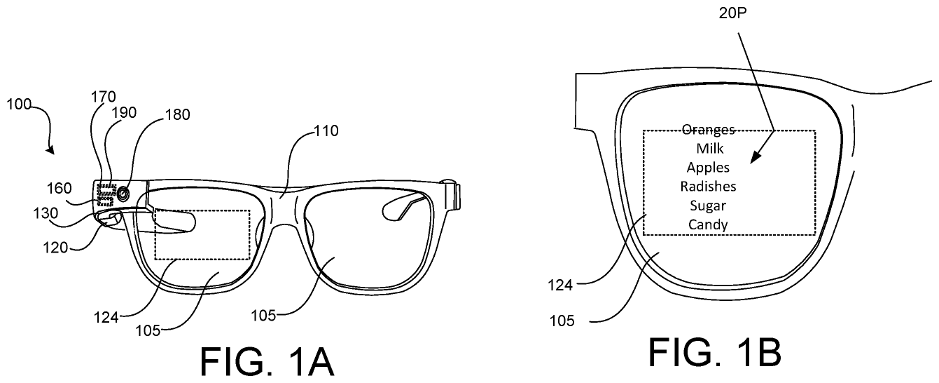

FIG. 1A is a front view of the example pair of smart glasses 100.

The pair of smart glasses 100 may be worn by a shopper, for example, while shopping in a store.

As shown in FIG. 1A, example smart glasses 100 may include a frame 110 holding a pair of see-through lenses 105 in front of a shopper's eyes. In some example implementations, a virtual display (e.g., display 124) may be overlaid on, or embedded in, at least one of the pair of see-through lenses 105 held in frame 110. In some implementations, display 124 may be a projected display on which additional information can be optically projected alongside what the wearer views through the glasses. In some implementations, display 124 may be an in-lens micro display. Such an optic design may allow the shopper to see both physical items in the real world, for example, through the lenses 105, next to content (for example, digital images, user interface elements, virtual content, and the like) shown on display 124.

Example smart glasses 100 may include a sensing system 160 including various sensing system devices, and a control system 170 including various control system devices to facilitate operation of the wearable device (i.e., smart glasses 100). Control system 170 may include electronic components such as processors, wireless transceivers, batteries, control buttons, etc. Processor 190 may be operably coupled to the components of control system 170 and also wirelessly coupled to external computing device(s) or system(s) (not shown). In some implementations, smart glasses 100 may include audio devices 130 (including, e.g., a speaker, a microphone, etc.) for processing by an external computer or auxiliary device (e.g., smart phone 200). Smart glasses 100 may also include an image recording device (i.e., a camera 180). In some implementations, camera 180 may be a forward-facing egocentric camera capable of capturing still and/or moving images.

The shopper may want to view on their smart glasses a shopping list of items (e.g., groceries) they plan to pick up once at a store. Each time the shopper picks up an item at the store, they would want to cross it off the shopping list to track what they need to shop for next. Unfortunately, it is difficult to hard to navigate through lists on the smart glasses form factor. Only a portion of the list may be in view at any given moment and scrolling through the list manually to find an item can be cumbersome and time-consuming as the display (e.g., display 124) on smart glasses is limited in size.

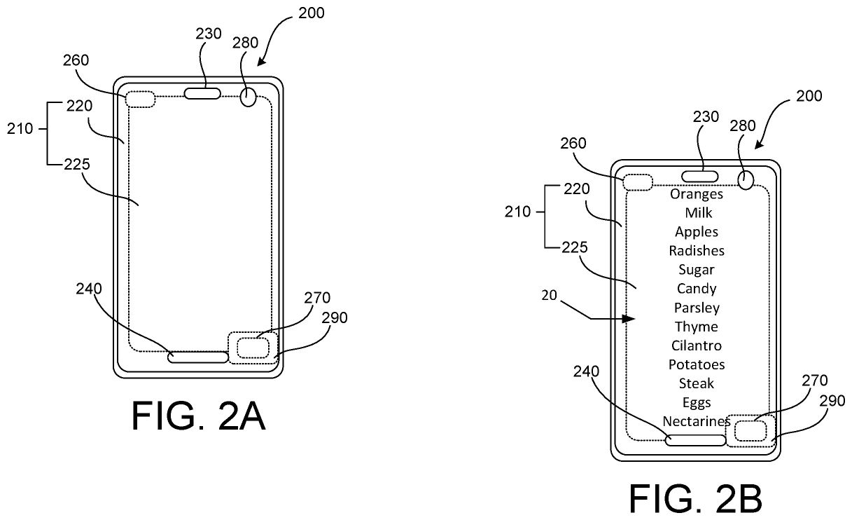

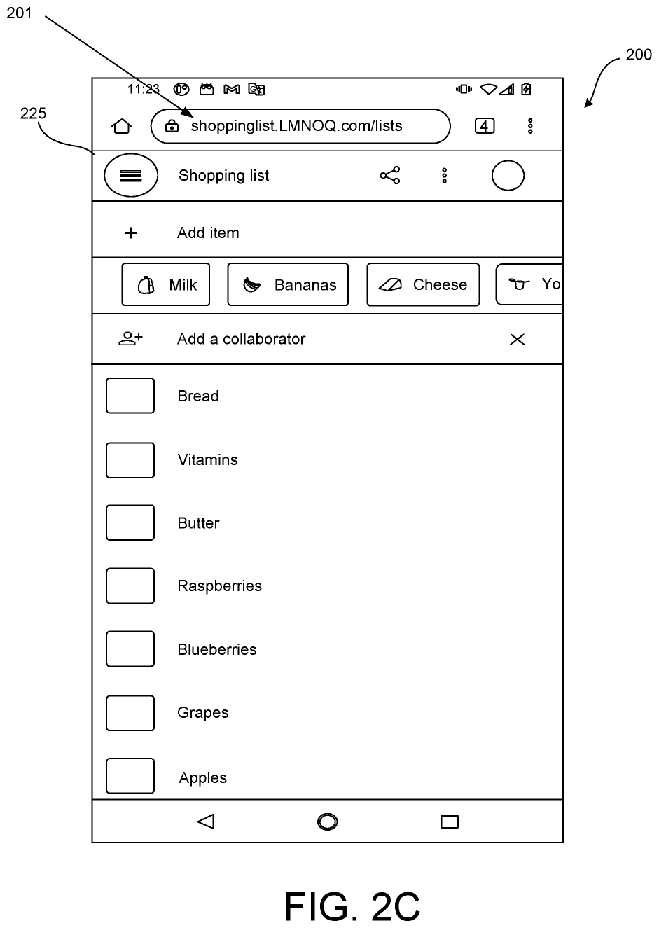

FIG. 1B is a schematic representation of a portion (e.g., grocery shopping list portion 20P) of a grocery shopping list 20 (FIG. 2B) that may be presented on virtual display (e.g., display 124) of smart glasses 100, worn by the shopper. Grocery shopping list 20 may be received from another external computing device (e.g., smart phone 200, FIG. 2A), or, in some example implementations grocery shopping list 20 may have been created in smart glasses 100 itself using, for example, voice commands to audio devices 130. Grocery shopping list 20 may have several line-item entries. Only a few of these may be presented on display 124 at a time because of the limited size of display 124.

FIG. 2A is a front view of a smart phone 200 that may be used, held, or carried by the shopper. Smart phone 200 may be wirelessly connected to smart glasses 100.

Example smart phone 200 may include an interface device 210. In some implementations, the interface device 210 may function as an output device, including, for example, a display portion 220, allowing the interface device 210 to output information to the user. In some implementations, the interface device 210 may function as an input device, including, for example, a touch input portion 225 that can receive, for example, touch inputs from the user. In some implementations, the interface device 210 can function as an input device and an output device. In some implementations, smart phone 200 includes a speaker 230 and a microphone 240 that detects audio signals for processing by smart phone 200 or by other wirelessly connected external computing systems (not shown) (other than smart glasses 100). In some implementations, smart phone 200 includes a camera 280, that can capture still and/or moving images in a field of view. Smart phone 200 may include a sensing system 260 including various sensing system devices, a control system 270 including various control system devices, and a processor 290, to facilitate operation of smart phone 200. Processor 290 may be wirelessly connected, in addition to smart glasses 100, to other external computing systems (not shown).

FIG. 2B is a schematic representation of a grocery shopping list 20 that may be presented on display portion 220 of smart phone 200 that may be used, held, or carried by the shopper. Grocery shopping list 20 may be created on smart phone 200 itself (e.g., by using apps for creating grocery lists, or by manually typing in text), or may be received from another external computing device (e.g., a desktop or laptop) (not shown).

FIG. 2C pictorially shows, for example, a user interface 201 of a shopping list app (e.g., Shoppinglist LMNPQ.com) that may be used on smart phone 200 to create grocery shopping lists (e.g., grocery shopping list 20).

Grocery shopping list 20 may be the same as the grocery shopping list, a portion of which (e.g., grocery shopping list portion 20P) is shown on display 124 in smart glasses 100 (FIG. 1B). The shopper may scroll through grocery shopping list 20 presented on display portion 220 of smart phone 200, for example, by swiping touch input portion 225. A similar touch input scrolling action is not available on smart glasses 100 for scrolling through the grocery shopping list portion 20P shown on display 124 of the smart glasses (FIG. 1B). Instead, the systems and methods of the present disclosure provide an auto-scroll feature on for scrolling through shopping lists on smart glasses

In accordance with the principles of the present disclosure, when the shopper is walking through a grocery store, and picks up a store item (e.g., an apple) in their hand, a camera (e.g., camera 280 in smart phone 200, or camera 180 in smart glasses 100, or other camera or imaging device) may record an image of the picked-up store item in the shopper's hand. The image may be compared with product images (e.g., images stored in a product directory database) to identify the picked-up store item (e.g., as an apple). A list controller may then automatically scroll the displayed grocery shopping list (e.g., grocery shopping list portion 20P displayed on smart glasses 100 and/or grocery shopping list 20 displayed on smart phone 200) to the line-item entry in grocery shopping list for the picked-up store item (e.g., an apple).

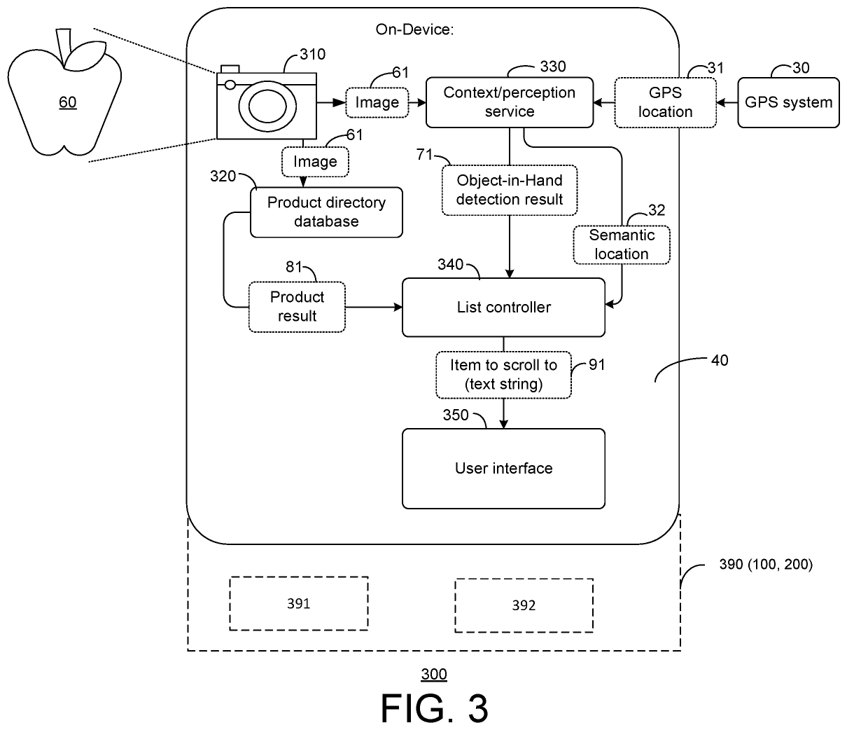

FIG. 3 is a block diagram of an example system 300 configured to detect and identify a store item held by a shopper, and to auto scroll to the detected store item in a display of a shopping list.

System 300 may be hosted or implemented on a computer system 390 including a processor 391 and a memory 392. Computer system 390 may be a standalone computer or an arrangement of distributed or networked computer systems (including e.g., smart phones, smart glasses, tablet computers, laptop computers, desktop computers, etc.). System 300 may be implemented on any device, or a combination of devices that have at least a camera for detecting and identifying items, and a capability of displaying a scrollable list.

In example implementations, system 300 may be implemented on an individual smart phone (e.g., smart phone 200), on an individual pair of smart glasses (e.g., smart glasses 100), or across a combination of the smart phone and the pair of smart glasses.

In FIG. 3, system 300 components are shown, for example, as being implemented on a computing device 40 (e.g., smart phone 200 and smart glasses 100). System 300 may, for example, include both software and hardware components. In example implementations, system 300 includes an imaging device 310, a product directory database 320, a context/perception service 330, a list controller 340, and user interface(s) 350.

System 300 may include or be coupled to a geolocation service or system (e.g., GPS system 30). Context/perception service 330 in conjunction with GPS system 30 (or other geolocation service (not shown)) may determine a location (e.g., GPS location 31) of device 40 (carried or worn by a shopper), for example, as being in a grocery store (e.g., XYZ grocery store on Main Street). In example implementations, context/perception service 330 may output a semantic location 32 (as a text string) based on GPS location 31 received from GPS system 30. Context/perception service 330 may, for example, output the semantic location 32 text string: “XYZ grocery store on Main Street”, to list controller 340.

In response, list controller 340 may notify the shopper's location (e.g., XYZ grocery store”) to the shopper on user interface 350 (e.g., on display 124 in smart glasses 100 and/or interface device 210 of smart phone 200).

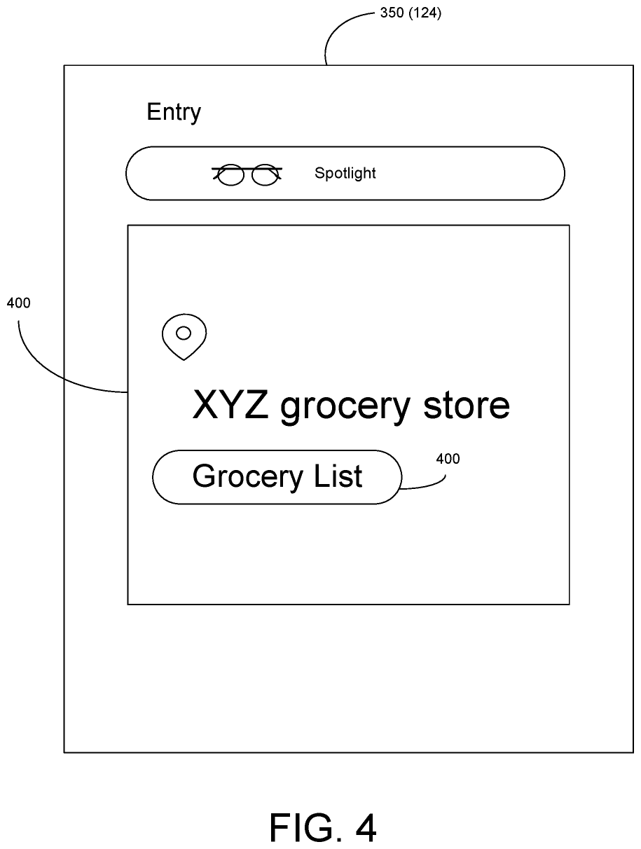

FIG. 4 is a schematic representation of an example notification 400 on user interface 350 (display 124 in smart glasses 100, and/or interface device 210 of smart phone 200) notifying the shopper that they are at the XYZ grocery store and that a grocery list is available.

In some example implementations, the shopper may activate display of the grocery list (e.g., grocery shopping list 20), for example, by a voice command to smart glasses 100 (or by tapping a button 401 on interface device 210 of smart phone 200).

In some example implementations, further, as the shopper enters and begins to walk in the store, list controller 340 may automatically begin displaying on user interface 350 (e.g., on display 124 in smart glasses 100 and/or interface device 210 of smart phone 200) the shopping list (e.g., grocery shopping list 20) that the shopper may have for the XYZ grocery store on Main Street.

With renewed reference to FIG. 3, in system 300, imaging device 310 may be a digital camera (e.g., camera 280 in smart phone 200, or camera 180 in smart glasses 100, or other camera or imaging device attached to, or external to, device 40).

In system 300, when an image (e.g., image 61) of a hand-held product (e.g., of an apple) is captured by imaging device 310, the captured image (e.g., image 61) may be compared with product images stored in a product directory database 320 to identify the item held in hand by the person. The product directory database 320 may be queried with image 61 to look up a product name 81 (e.g., Honey Crisp Apple) in the product directory that is a likely match for the image.

Further, the image (e.g., image 61) may be sent to context/perception service 330 for contextual confirmation that the image (e.g., image 61) relates to a grocery store shopping context (e.g., at XYZ grocery store on Main Street). Context/perception service 330 may produce a confidence value (e.g., Object-In-Hand or OIH confidence result 71) that image 61 represents a store item (apple 60) the shopper is holding in their hand. OIH confidence result 71 may have a value, for example, between 0 and 1. Context/perception service 330 may send the confidence value (i.e., OIH confidence result 71) to list controller 340.

When OIH confidence result 71 is above a predetermined threshold value (e.g., x>0.5, or x>0.7, etc.), list controller 340 may, based on the semantic location (e.g., semantic location 32) and the product name 81 (e.g., product name 81) found in the product directory, send a text string (e.g., apple) related to the product name to user interface 350.

If the text string semantically matches an item entry (e.g., apple) in the shopping list displayed on user interface 350, list controller 340 may automatically scroll the shopping list to the item entry. In some implementations, the semantic matching could be more sophisticated or more general than a strict alphabetical or character string match. For example, the semantic matching may match an item text string: “apple,” to a general list item “fruit.”

Further, in some example implementations, list controller 340 may automatically mark the item entry in the shopping list with the matching text string as being completed. List controller 340 may automatically mark the item entry in the shopping list as being completed. List controller 340 may mark the item entry by highlighting the text, for example, by striking the text of the item entry, or by marking a check box for the item entry, or coloring the text of the item entry, etc.

In some example implementations, the shopper may be given an option of undoing the automatic marking of the item entry as completed, for example, by a voice command to smart glasses 100 (or other input to smart phone 200).

In some example implementations, in which list controller 340 does not automatically mark the item entry in the shopping list with the matching text string as being completed, the shopper may have an option of marking the item entry as completed, for example, by a voice command to smart glasses 100 (or other input to smart phone 200).

In some example implementations, list controller 340 may move item line entries that are marked as being completed to a bottom or lower portion of the grocery shopping list (e.g., grocery shopping list 20) on smart phone 200 (below unmarked item line entries). Since only a portion (e.g., grocery shopping list portion 20P) of a grocery shopping list 20 (FIG. 2B) is presented on the virtual display (e.g., display 124) of smart glasses 100, moving item entries that are marked as being completed to the bottom of the grocery shopping list may cause these completed item entries to drop out of view on display 124.

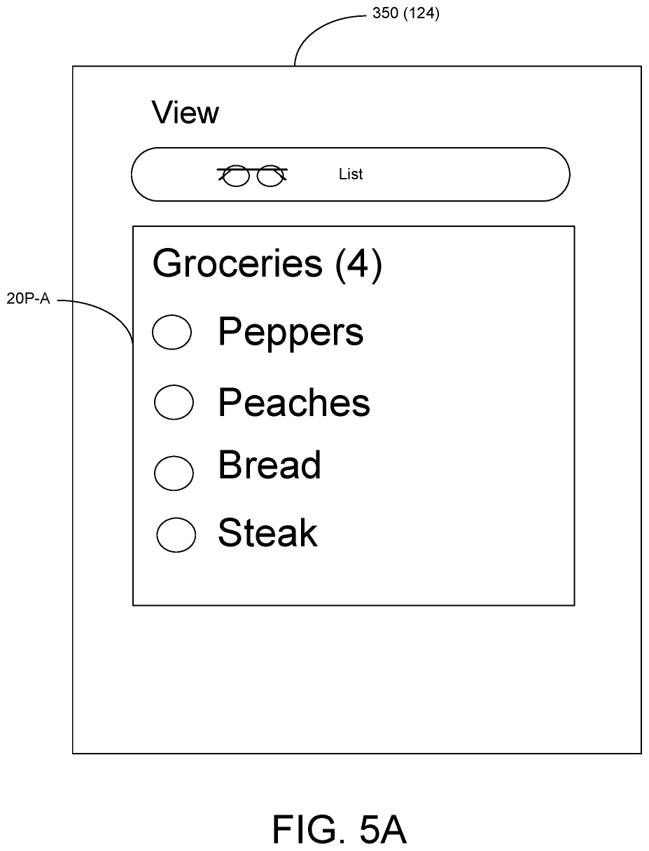

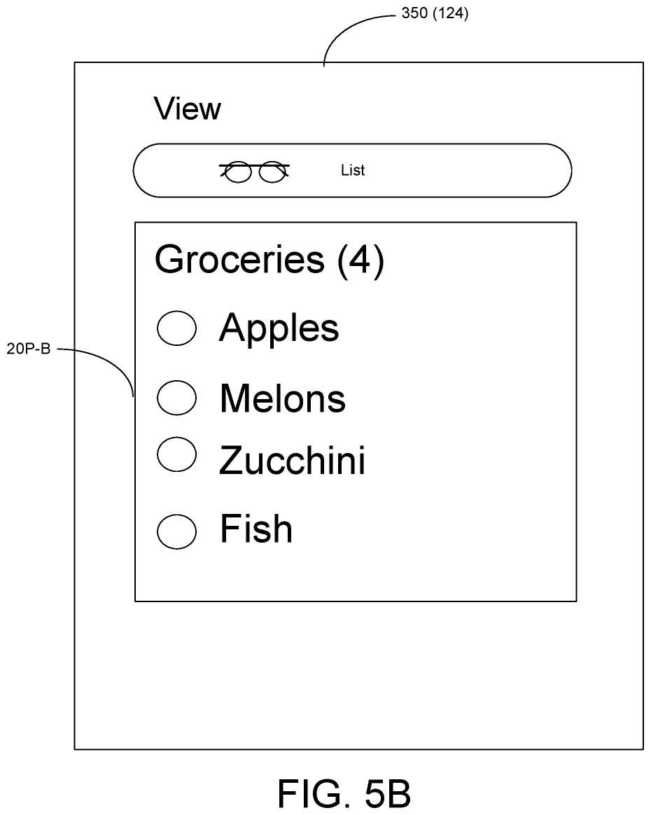

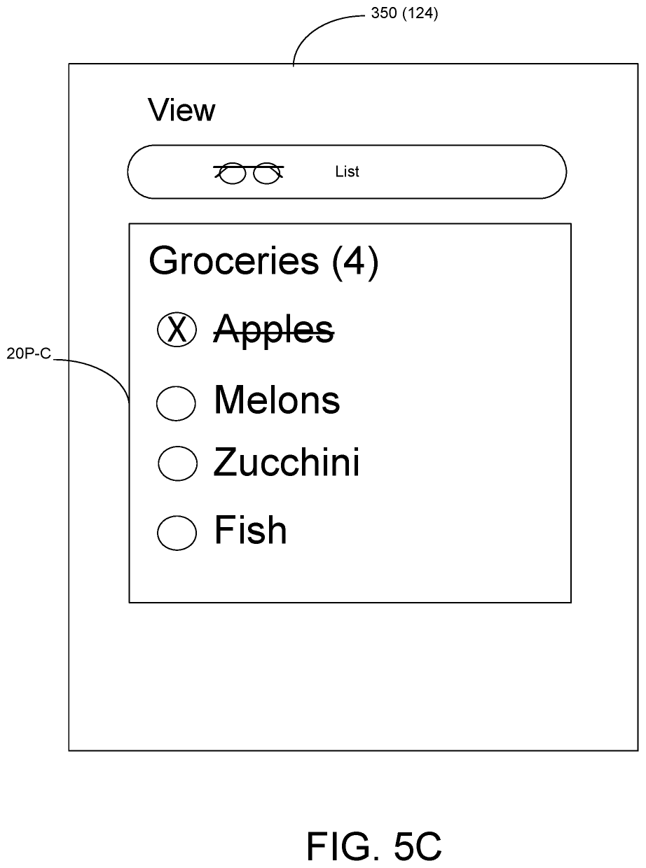

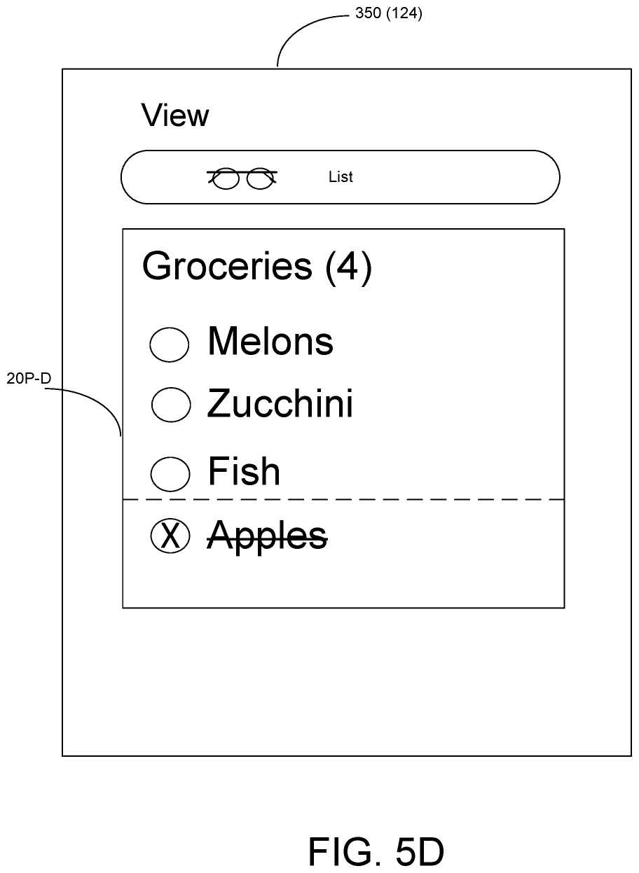

FIGS. 5A, 5B, 5C and 5D show examples of grocery list portions (e.g., portions 20P-A, 20P-B, 20P-C, and 20P-D) that may be displayed to the shopper on display 124 in smart glasses 100 that the shopper may be wearing.

FIG. 5A shows an example grocery shopping list portion 20P-A of a grocery shopping list 20 (FIG. 2B) initially presented to the shopper on display 124 of smart glasses 100. Depending on the size of display 124 only a few item line entries (e.g., 2-6 line entries) may fit in or can be shown on display 124. For example, only four item line entries (e.g., Peppers, Peaches, Bread, and Steak) of the grocery shopping list are displayed on display 124 in smart glasses 100.

As shown in FIG. 5B, after a store item (e.g., apple 60) is picked up and imaged in the hands of the shopper, list controller 340 auto-scrolls the grocery list to bring the item line entry (e.g., Apples) to the top of the four item line entries of grocery shopping list portion 20P-B shown on display 124 in smart glasses 100. FIG. 5A shows, for example, the four item line entries (e.g., Apples, Melons, Zucchini and Fish) of the grocery shopping list are displayed on display 124 in smart glasses 100.

Next the scrolled-to store item (i.e., Apples) may be marked as completed automatically by list controller 340 or by a voice command form the shopper. FIG. 5C shows, for example, in grocery shopping list portion 20P C shown on display 124 in smart glasses 100, the line-entry for Apples with an “X” mark in the check box preceding the text “Apples” and a strike through the text (i.e., indicating completion of the-grocery list item line entry (Apples).

Next, list controller 340 may move the item line entries (e.g., Apples) that are marked as completed to a bottom of grocery shopping list 20 below uncompleted (unmarked) item line entries. The completed item line entries may be so far below uncompleted item line entries that they may not be right away included in a next set of four item line entries of grocery shopping list portion 20P shown on display 124 in smart glasses 100. However, FIG. 5D illustrates the concept of moving completed item line entries to the bottom of grocery shopping list 20 by showing, for example, in grocery shopping list portion 20P-D shown on display 124 in smart glasses 100, the completed item line entry for apples as being moved to the bottom of the four item line entries (i.e., Apples, Melons, Zucchini, Fish) of grocery shopping list portion 20P-C shown on display 124 in FIG. 5C. FIG. 5D shows the grocery shopping list portion 20P, for example, as: Melons, Zucchini, Fish, Apples,

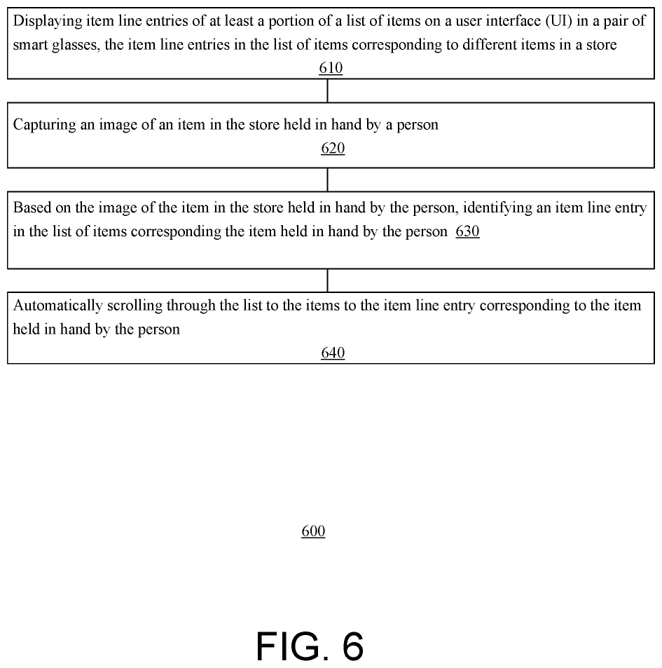

FIG. 6 illustrates an example computer-implemented method 600 for displaying a list of items (e.g., a grocery shopping list) on a user interface (UI) in a pair of smart glasses or a heads-up display glasses. Different item line entries in the list may correspond, for example, to different items in a store. Each item line entry may include text and/or graphics representing a respective item.

Method 600 includes displaying line entries of at least a portion of a list of items on a user interface (UI) in a pair of smart glasses worn by a person, the item line entries in the list of items corresponding to different items in a store (610); and capturing an image of an item in the store held in hand by the person (620).

In method 600, displaying line entries of at least a portion of a list on a user interface in a pair of smart glasses 610 may include also displaying or activating the list on a smart phone (or other computing device) accompanying the person. Method 600 may include using a Global Positioning System (GPS) (or other geolocation service) associated with the person to determine a location of the person, and when the person's location correspond to the store's location, presenting a notification of the person's location on the UI, and also presenting an availability of the list of items (e.g., the grocery shopping list) on the UI.

Method 600 further includes, based on the image of the item in the store held in hand by the person, identifying an item line entry in the list corresponding to the item held in hand by the person (630), and automatically scrolling through the list of items to the item line entry corresponding to the item held in hand by the person (640).

In method 600, capturing an image of an item in the store held in hand by a person 420 may include capturing an image with a camera in the pair of smart glasses, or a camera in the smart phone accompanying the person, or a third-party camera.

Method 600 further includes identifying an item line entry in the list corresponding to the item held in hand by the person (630), and automatically scrolling through the list to the item line entry in the list corresponding to the item held in hand by the person (640). Automatically scrolling through the list to the item line entry in the list corresponding to the item held in hand by the person 640 may include displaying the item line entry in the portion of the list in the display on the user interface.

In method 600, identifying an item line entry in the list corresponding to the item held in hand by the person includes comparing the captured image with product images stored in a product directory database to identify the item held in hand by the person.

In method 600, capturing the image of the item in the store held in hand by the person includes capturing the image using a camera in the pair of smart glasses.

In method 600, capturing the image of the item in the store held in hand by the person includes capturing the image using a camera in a smart phone accompanying the person.

In method 600, automatically scrolling through the list to the item line entry in the list includes marking the item line entry by striking text of the item line entry, and/or by marking a check box for the item line entry, and/or coloring the text of the item line entry.

In method 600, automatically scrolling through the list to the item line entry in the list further includes moving item line entries that are marked as being completed to a lower portion of the list below unmarked item line entries.

In method 600, displaying item line entries of at least a portion of the list on the UI in the pair of smart glasses includes also activating the list on a smart phone accompanying the person.

In method 600, further includes: using a Global Positioning System (GPS) associated with the person to determine a location of the person; and when the person's location corresponds to the store's location, presenting a notification of the person's location on the UI, and presenting an availability of the list of items on the UI.

In method 600, identifying an item line entry in the list corresponding to the item held in hand by the person includes comparing the captured image with product images stored in a product directory database to identify the item held in hand by the person.

Method 600 further includes querying the product directory database with the captured image to look up a product name that is a match for the captured image.

Method 600 further includes sending a text string related to the product name found in the product directory to the UI interface.

In method 600, automatically scrolling through the list to the item line entry in the list corresponding to the item held in hand by the person includes verifying that the text string matches an item line entry in the displayed list and then automatically scrolling the list to the item line entry.

In method 600, identifying the item line entry in the list corresponding to the item held in hand by the person, further includes sending the captured image to a service for contextual confirmation that the image relates to a store context. The service produces a confidence value that captured image represents a store item held in hand by the person. Method 600 further involves, when the confidence value that the item is held in hand by the person is above a predetermined threshold value, sending a text string related to a name of the item to the UI.

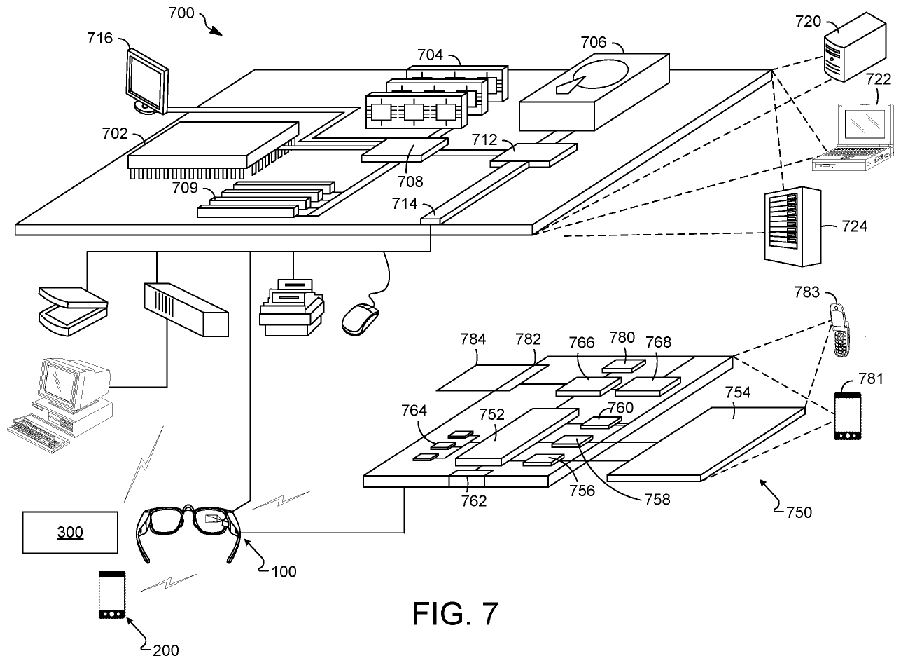

FIG. 7 illustrates an example of a computer device 700 and a mobile computer device 750, which may be used with system 300 (and the consumer electronic devices such as smart glasses 100 and smart phone 200 that can incorporate components of system 300) and the shopping list display techniques described here (e.g., to implement one or more of the example first computing devices and one or more of the second computing devices). The computing device 700 includes a processor 702, memory 704, a storage device 706, a high-speed interface 708 connecting to memory 704 and high-speed expansion ports 710, and a low-speed interface 712 connecting to low-speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high-speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 can provide mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 704, the storage device 706, or memory on processor 702.

The high-speed controller 708 manages bandwidth-intensive operations for the computing device 700, while the low-speed controller 712 manages lower bandwidth-intensive operations. Such allocation of functions is example only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in several different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display), and LED (Light Emitting Diode) or an OLED (Organic Light Emitting Diode) display, or other appropriate display technology. The display interface 756 may include appropriate circuitry for driving the display 754 to present graphical and other information to a user. The control interface 758 may receive commands from a user and convert them for submission to the processor 752. In addition, an external interface 762 may be provided in communication with processor 752, to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In-Line Memory Module) card interface. Such expansion memory 774 may provide extra storage space for device 750 or may also store applications or other information for device 750. Specifically, expansion memory 774 may include instructions to carry out or supplement the processes described above and may include secure information also. Thus, for example, expansion memory 774 may be provided as a security module for device 750 and may be programmed with instructions that permit secure use of device 750. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752, that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation- and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in several different forms, as shown in the figure. For example, it may be implemented as a cellular telephone 780. It may also be implemented as part of a smartphone 782, personal digital assistant, or another similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, one or more input devices included on, or connect to, the computing device 750. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device.

In some implementations, one or more output devices included on the computing device 750 can provide output and/or feedback to a user. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, a computing device 750 may include a touchscreen. For example, a user can interact with the touchscreen to interact with a user interface for a controllable device. For example, the touchscreen may include user interface elements such as sliders that can control properties of the controllable device.

Computing device 700 is intended to represent various forms of digital computers and devices, including, but not limited to laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be examples only, and are not meant to limit implementations of the inventions described and/or claimed in this document.

Several embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

Further to the descriptions above, a user may be provided with controls allowing the user to make an election as to both when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A computer-implemented method, comprising:
displaying item line entries of at least a portion of a list of items on a user interface (UI) in a pair of smart glasses worn by a person, the item line entries in the list of items corresponding to different items in a store;
capturing an image of an item in the store held in hand by the person;
based on the image of the item in the store held in hand by the person, identifying an item line entry in the list of items corresponding to the item held in hand by the person; and
automatically scrolling through the list of items to the item line entry corresponding to the item held in hand by the person.

2. The computer-implemented method of claim 1, wherein capturing the image of the item in the store held in hand by the person includes capturing the image using a camera in the pair of smart glasses.

3. The computer-implemented method of claim 1, wherein capturing the image of the item in the store held in hand by the person includes capturing the image using a camera in a smart phone accompanying the person.

4. The computer-implemented method of claim 1, wherein automatically scrolling through the list of items to the item line entry in the list of items further includes marking the item line entry as completed by striking text of the item line entry, and/or marking a check box for the item line entry, and/or coloring text of the item line entry.

5. The computer-implemented method of claim 4, wherein automatically scrolling through the list of items to the item line entry in the list of items further includes moving the item line entry that is marked as being completed to a lower portion of the list of items below unmarked item line entries in the list of items.

6. The computer-implemented method of claim 1, wherein displaying the item line entries of at least the portion of the list of items on the UI in the pair of smart glasses includes activating the list of items on a smart phone in communication with the pair of smart glasses.

7. The computer-implemented method of claim 1, further comprising:
determining a location of the person using a Global Positioning System (GPS) associated with the person; and
when the location of the person corresponds to a location of the store, presenting a notification of the location of the person on the UI, and presenting an availability of the list of items on the UI.

8. The computer-implemented method of claim 1, wherein identifying an item line entry in the list of items corresponding to the item held in hand by the person includes comparing the image of the item in the store held in hand by the person with product images stored in a product directory database to identify the item held in hand by the person.

9. The computer-implemented method of claim 8, further comprising:
querying the product directory database with the image of the item in the store held in hand by the person to look up a product name that is a match for the image of the item in the store held in hand by the person.

10. The computer-implemented method of claim 9, further comprising:
sending a text string related to the product name found in the product directory database to the UI.

11. The computer-implemented method of claim 10, wherein automatically scrolling through the list of items to the item line entry in the list of items corresponding to the item held in hand by the person includes verifying that the text string matches an item line entry in the list of items and then automatically scrolling the list of items to the item line entry.

12. The computer-implemented method of claim 1, wherein identifying the item line entry in the list of items corresponding to the item held in hand by the person, further comprises:
sending the image of the item in the store held in hand by the person to a service for contextual confirmation that the image relates to a store context, the service producing a confidence value that image of the item in the store held in hand by the person represents a store item held in hand by the person; and
when the confidence value that the store item is held in hand by the person is above a predetermined threshold value, sending a text string related to a name of the item to the UI.

13. A system, comprising:
at least one processor; and
a memory, wherein the at least one processor is configured to execute instructions stored in the memory to:
display, on a user interface (UI) in a pair of smart glasses worn by a person, item line entries of at least a portion of a list of items corresponding to different items in a store;
capture an image of an item in the store held in hand by a person;
based on the image of the item in the store held in hand by the person, identify an item line entry in the list of items corresponding to the item held in hand by the person; and
automatically scroll through the list of items to the item line entry in the list of items corresponding to the item held in hand by the person.

14. The system of claim 13, wherein capturing the image of the item in the store held in hand by the person includes capturing the image using a camera in the pair of smart glasses.

15. The system of claim 13, wherein capturing the image of the item in the store held in hand by the person includes capturing the image using a camera in a smart phone accompanying the person.

16. The system of claim 13, wherein automatically scrolling through the list of items to the item line entry in the list of items further includes marking the item line entry as being completed by striking text of the item line entry, and/or by marking a check box for the item line entry, and/or coloring text of the item line entry.

17. The system of claim 16, wherein automatically scrolling through the list of items to the item line entry in the list of items further includes moving item line entries that are marked as being completed to a lower portion of the list of items below unmarked item line entries in the list of items.

18. The system of claim 13, wherein identifying an item line entry in the list of items corresponding to the item held in hand by the person includes comparing the image of the item in the store held in hand by the person with product images stored in a product directory database to identify the item held in hand by the person and querying the product directory database with the image of the item in the store held in hand by the person to look up a product name that is a match for the image of the item in the store held in hand by the person.

19. A system, comprising:
at least one processor;
a memory;
an imaging device configured to capture an image of an item held in a hand of a person in a store; and
a user interface in a pair of smart glasses,
wherein the at least one processor configured to execute instructions to:
display a portion of a shopping list of items on the user interface;
identify the item held in the hand of the person; and
auto scroll the portion of the shopping list of items displayed on the user interface to an item line entry in the shopping list of items corresponding to the item held in the hand of the person.

20. The system of claim 19, wherein the at least one processor further configured to execute instructions to:
mark the item line entry as being completed by striking text of the item line entry, and/or by marking a check box for the item line entry, and/or coloring text of the item line entry.

21. The system of claim 20, wherein the at least one processor further configured to execute instructions to:
moving item line entries that are marked as being completed to a lower portion of the shopping list of items below unmarked item line entries in the shopping list of items.
